(19) United States
(12) Patent Application Publication
(10) Pub. No.: US 2013/0107379 A1
(43) Pub. Date: May 2, 2013

(54) ADJUSTABLE LENS HOLDER

(71) Applicant: TSUNG-SHIH LEE, New Taipei (TW)

(72) Inventor: TSUNG-SHIH LEE, New Taipei (TW)

(73) Assignee: Cheng Uei Precision Industry Co., LTD., New Taipei City (TW)

(21) Appl. No.: 13/283,569

(22) Filed: Oct. 27, 2011

(51) Int. Cl. G02B 7/02

(52) U.S. Cl. 359/811

(57) ABSTRACT

Provided is an adjustable lens holder, including a base, a plurality of main elastic members, a plurality of adjustment bolts and a pressing member. The base is a frame defining an opening. A periphery of the opening disposes a plurality of recesses on a front surface of the base to accommodate the protruding portions of the lens. The main elastic members are disposed on one sidewall of the base. The adjustment bolts are disposed on another sidewall of the base opposite to the one sidewall thereof. The pressing member is fixed on the front surface of the frame for tightly pressing the lens. The present invention employs the main elastic members and the adjustment bolts to hold two opposite edges of the lens. The adjustment bolts can be turned to adjust the relative position of the lens thereby improving the efficiency of adjusting the optical path.

### BACKGROUND OF THE INVENTION

1. Field of the Invention

The present invention relates to a lens holder, and more particularly to an adjustable lens holder.

2. Description of the Prior Art

A lens holder is a frame for holding a lens and is widely used in an optical field. In the prior art, an adjustable lens holder retains a lens by a plurality of adjustment bolts. One end of each adjustment bolt forms a recess to receive the side edge of the lens. By the rotation of the adjustment bolt, the adjustment bolt can engage with the screw hole and is pressed onto the side edge of the lens thereby fixing and adjusting the relative position of the lens to form a wanted optical path.

However, for the above structure, when the user loosens any one of the adjustment bolts to change the relative position of the lens for obtaining the wanted optical path, the lens will be loose and be under an unstable danger state due to lacking the support of the adjustment bolt. It is obvious that in the prior art, another adjustment bolt supporting the other end of the lens also must be simultaneously adjusted when adjusting any one of the adjustment bolts so that ensuring the lens under a stable balance state. Hence, in the prior art, the above adjustment way has the disadvantage of being difficult and complicated to adjust, so that the prior art is bad for improving the efficiency of adjusting the optical path.

### BRIEF SUMMARY OF THE INVENTION

For solving the problem in the above prior art, an object of the present invention is to provide an adjustable lens holder having the advantages of being easy and simplified to adjust the lens position.

To achieve the above object, in accordance with the present invention, an adjustable lens holder is provided, comprising a base, a plurality of main elastic members, a plurality of adjustment bolts and a pressing member. The base is a frame defining an opening on a center thereof. A periphery of the opening disposes a plurality of recesses, which extend backward from a front surface of the frame and are adapted to accommodate and retain the protruding portions of the lens. The main elastic members are disposed on one sidewall of the base and protrude into the inside of the frame. The adjustment bolts are disposed on another sidewall of the base opposite to the one sidewall thereof. The adjustment bolts pass through the base from the outside of the base to protrude into the inside of the base. The pressing member is fixed on the front surface of the frame for tightly pressing and retaining the lens in the base.

Based on the above description, the adjustable lens holder of the present invention employs a plurality of the main elastic members and the adjustment bolts to hold two opposite edges of the lens. The adjustment bolts can be turned by a tool to go forward or backward to adjust the relative position of the lens thereby improving the efficiency of adjusting the optical path.

### BRIEF DESCRIPTION OF THE DRAWINGS

FIG. 1 is a perspective view of one embodiment of an adjustable lens holder of the present invention.

FIG. 2 is an exploded view of the adjustable lens holder shown in FIG. 1.

FIG. 3 is a perspective view before a lens is mounted on the adjustable lens holder of FIG. 1.

FIG. 4 is a perspective view after the lens is mounted on the adjustable lens holder of FIG. 3.

### DETAILED DESCRIPTION OF THE PREFERRED EMBODIMENTS

The following embodiment with reference to the accompanying drawings now has been given for detail describing the technology, the feature, the object and the effect of the present invention.

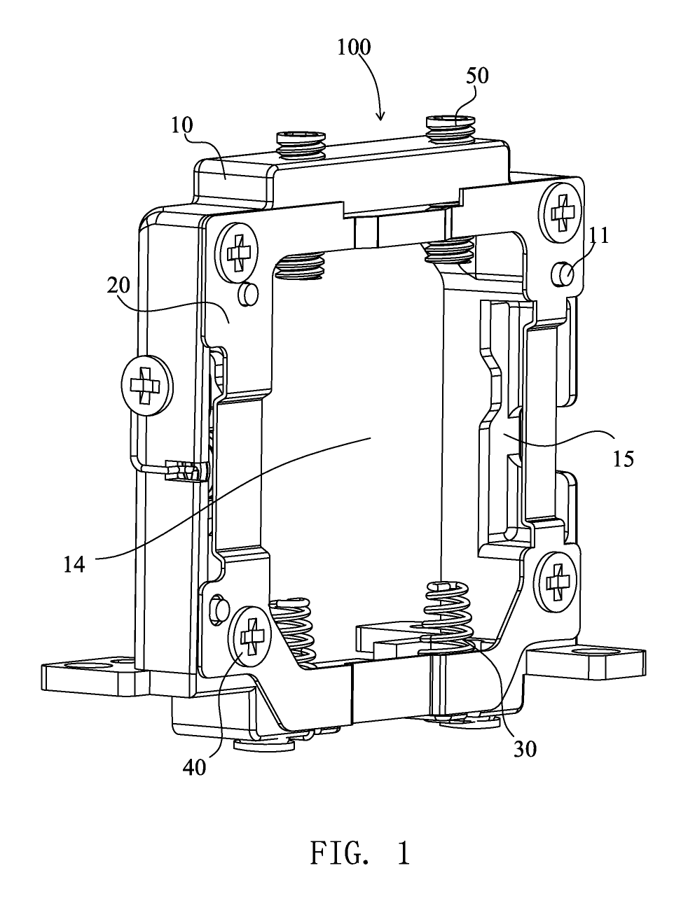

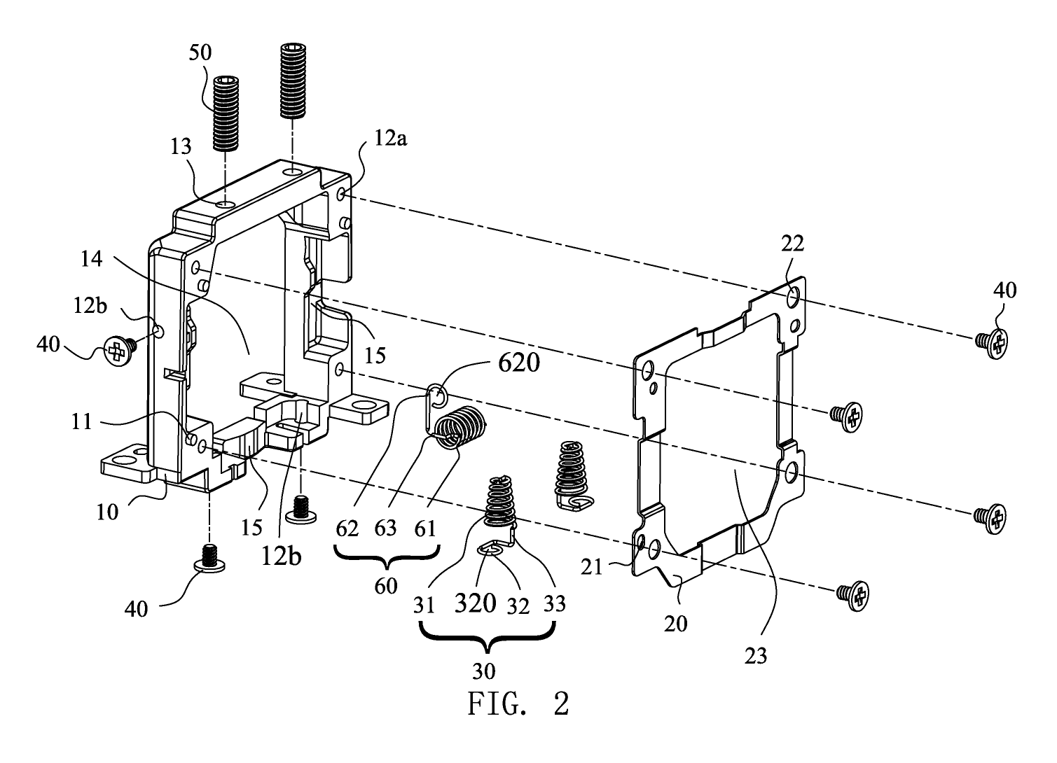

Please refer to FIGS. 1-3, an adjustable lens holder 100 of the present invention comprises a base 10, a plurality of main elastic members 30, a plurality of adjustment bolts 50, an auxiliary elastic member 60 and a pressing member 20. In one embodiment, the base 10 is a frame defining an opening 14 on a center thereof. A periphery of the opening disposes a plurality of recesses 15, which extend backward from a front surface of the frame and are adapted to accommodate and hold protruding portions 201 of a lens 200. The front surface of the base 10 disposes a plurality of locating posts 11 perpendicularly protruding thereon and extending forward, and a plurality of positioning screw holes 12a thereon. The base 10 also disposes a plurality of retaining screw holes 12b and a plurality of adjustment screw holes 13 on the sidewalls of the frame thereof. In this embodiment, the retaining screw holes 12b are formed on the left sidewall and the bottom sidewall of the frame, and the adjustment screw holes 13 are formed on the top sidewall of the frame. The retaining screw holes 12b on the bottom sidewall of the frame are provided for retaining these main elastic members 30, the retaining screw hole 12b on the left sidewall of the frame is provided for retaining the auxiliary elastic member 60, and the adjustment screw holes 13 are opposite to the retaining screw holes 12b located on the bottom sidewall and are provided for retaining the adjustment bolts 50. These adjustment screw holes 13 are communicated with the opening 14.

Each of the main elastic members 30 has an elastic portion 31 and a latch portion 32 extending from the elastic portion 31. There forms a bending structure 33 between the elastic portion 31 and the latch portion 32. When assembling, the bending structure 33 of the main elastic member 30 is hooked on the base 10, so that the elastic portion 31 of the main elastic member 30 can enter into and be fixed on the inner side of the bottom sidewall of the frame of the base 10, and the latch portion 32 of the main elastic member 30 is located on the outside of the bottom sidewall of the frame of the base 10. An aperture 320 of the latch portion 32 of each main elastic member 30 is aligned to the corresponding retaining screw hole 12b located on the bottom sidewall of the frame of the base 10. One retaining screw 40 passes through the aperture 320 of the latch portion 32 and is tightened in the corresponding retaining screw hole 12b located on the bottom sidewall of the base 10, thereby fixing the main elastic member 30 on the base 10.

The auxiliary elastic member 60 has an elastic portion 61 and a latch portion 62 extending from the elastic portion 61. There forms a bending structure 63 between the elastic portion 61 and the latch portion 62. When assembling, the bending structure 63 of the auxiliary elastic member 60 is hooked on the base 10, so that the elastic portion 61 of the auxiliary elastic member 60 can protrude into and be fixed on the inner side of the left sidewall of the frame of the base 10, and the latch portion 62 of the auxiliary elastic member 60 is located on the outside of the frame of the base 10. An aperture 620 of the latch portion 62 of the auxiliary elastic member 60 is aligned to the corresponding retaining screw hole 12b located on the left sidewall of the frame of the base 10. One retaining screw 40 passes through the aperture 620 of the latch portion 62 and is tightened in the corresponding retaining screw hole 12b located on the left sidewall of the base 10, thereby fixing the auxiliary elastic member 60 on the base 10.

The above-mentioned main elastic members 30 or the auxiliary elastic member 60 may be a spring or a leaf spring. In this embodiment, the main elastic members 30 and the auxiliary elastic member 60 are compression springs.

The adjustment bolts 50 are positioned in the adjustment screw holes 13 located on the top sidewall of the base 10 and are opposite to and the main elastic members 30. Each adjustment bolt 50 passes through the corresponding adjustment screw hole 13 from the outside of the frame of the base 10 to protrude into the inside of the base 10. Preferably, each adjustment bolt 50 is aligned to the corresponding main elastic member 30.

The pressing member 20 is a thin plate defining an opening 23 and has a plurality of locating holes 21 and a plurality of retaining holes 22 for being corresponding to the locating posts 11 and the positioning holes 12a located on the front surface of the base 10, respectively. The pressing member 20 is mounted on the front surface of the base 10. Now, each locating post 11 passes through the corresponding locating hole 21, and each retaining hole 22 is aligned to the corresponding positioning hole 12a. One retaining screw 40 passes through the retaining hole 22 and is tightened in the positioning hole 12a, so that fixing the pressing member 20 onto the base 10.

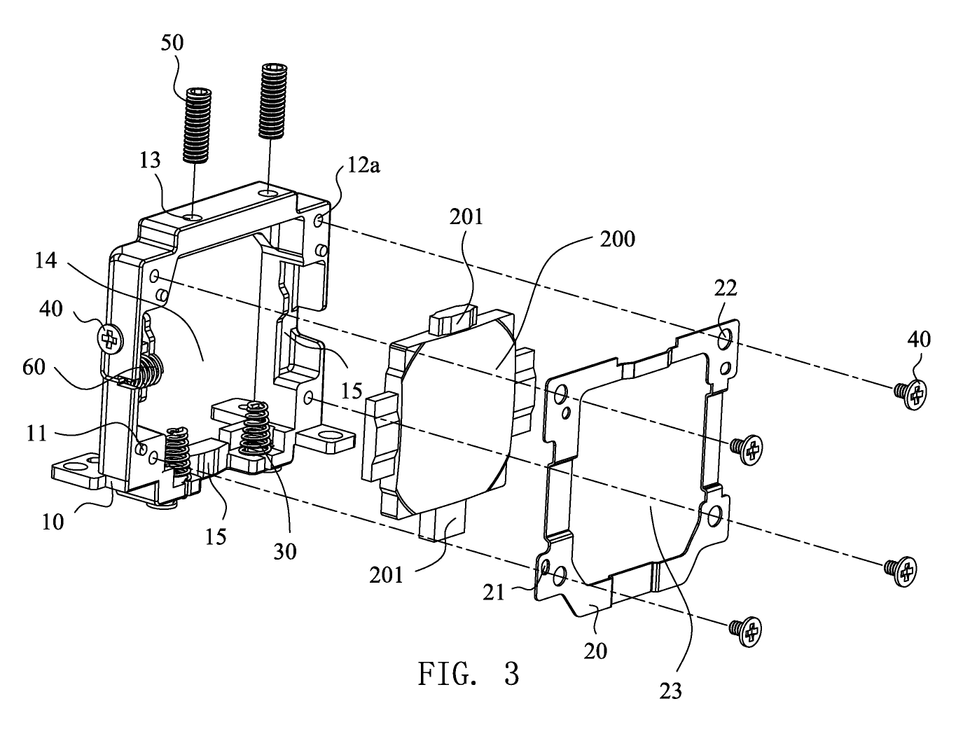

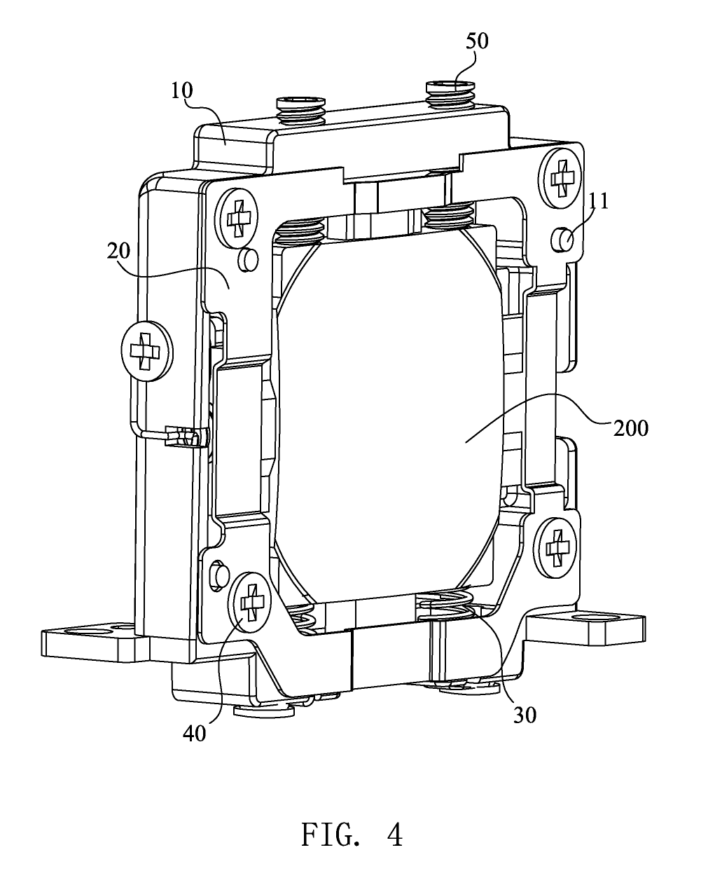

Please refer to FIGS. 3 and 4, when assembling the lens 200 on the base 10 provided with the main elastic members 30 and the auxiliary elastic member 60, first, the protruding portions 201 of the lens 200 are separately accommodated in the corresponding recesses 15 of the base 10 provided with the main elastic members 30 and the auxiliary elastic member 60, wherein the main elastic members 30 located on the bottom sidewall of the base 10 can press against the bottom edge of the lens 200, and the auxiliary elastic member 60 located on the left sidewall of the base 10 can press against the left edge of the lens 200. Then, the pressing member 20 is mounted on the front surface of the base 10 having the recesses 15, wherein each locating post 11 passes through the corresponding locating hole 21 so that making the retaining holes 22 being aligned to the corresponding positioning screw holes 12a, and several retaining screws 40 are employed to respectively pass through the corresponding retaining holes 22 and are tightened in the corresponding positioning screw holes 12a so that the pressing member 20 being fixed on the front surface of the base 10 and being used to tightly press the lens 200. Finally, the adjustment bolts 50 pass through the corresponding adjustment screw holes 13 from the outside of the base 10 to enter into the inside of the base 10 so that the bottom surfaces of the adjustment screw holes 13 can press against the top edge of the lens 200.

As described above, the adjustable lens holder 100 of the present invention employs a plurality of the main elastic members 30 and a plurality of the adjustment bolts 50 to hold two opposite edges of the lens 200. When needing to adjust the relative position of the lens 200, the adjustment bolts 50 can be turned by a tool to go forward or backward and the moving distance of the adjustment bolts 50 can be controlled to determine the relative position of the lens 200 thereby improving the efficiency of adjusting the optical path.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An adjustable lens holder for holding a lens, a peripheral of which forms a plurality of protruding portions thereon, the adjustable lens holder comprising:
a base being a frame defining an opening on a center thereof, a periphery of the opening disposing a plurality of recesses, which extend backward from a front surface of the frame and are adapted to accommodate and retain the protruding portions of the lens;
a plurality of main elastic members being disposed on one sidewall of the base and protruding into the inside of the frame;
a plurality of adjustment bolts being disposed on another sidewall of the base opposite to the one sidewall thereof; and
a pressing member being fixed on the front surface of the frame for tightly pressing and retaining the lens in the base.

2. The adjustable lens holder as claimed in claim 1, wherein the main elastic member may be a spring or a leaf spring.

3. The adjustable lens holder as claimed in claim 2, wherein the spring may be a compression spring.

4. The adjustable lens holder as claimed in claim 1, wherein the adjustment bolts are respectively aligned to the main elastic members.

5. The adjustable lens holder as claimed in claim 1, wherein the adjustment bolts pass through the base from the outside of the base to protrude into the inside of the base.

6. The adjustable lens holder as claimed in claim 1, wherein each of the main elastic members is fixed on the one sidewall of the base by a retaining screw.

7. The adjustable lens holder as claimed in claim 1, wherein the pressing member is fixed on the front surface of the base by a plurality of retaining screws.

8. The adjustable lens holder as claimed in claim 1, further comprising an auxiliary elastic member, which is fixed the other sidewall of the base having no the main elastic members and the adjustment bolts mounted thereon.

9. The adjustable lens holder as claimed in claim 8, wherein the auxiliary elastic member may be a spring or a leaf spring.

10. The adjustable lens holder as claimed in claim 9, wherein the spring may be a compression spring.

11. The adjustable lens holder as claimed in claim 8, wherein the auxiliary elastic member is fixed on the base by a retaining screw.
